(19) United States
(12) Patent Application Publication
(10) Pub. No.: US 2018/0317605 A1
(43) Pub. Date: Nov. 8, 2018

(54) FOOTWEAR ITEM AND METHODS USING STROBEL STITCHING

(71) Applicants: Peter Bastianelli, Dunfermline (GB); Chad Kelly, Raytown, MO (US)

(72) Inventors: Peter Bastianelli, Dunfermline (GB); Chad Kelly, Raytown, MO (US)

(73) Assignee: BHA Altair, LLC, Franklin, TN (US)

(21) Appl. No.: 15/968,455

(22) Filed: May 1, 2018

Related U.S. Application Data
(60) Provisional application No. 62/501,214, filed on May 4, 2017.

(51) Int. Cl. A43B 23/02; A43B 1/14; A43B 7/06; A43B 7/12; A43B 9/02; A43B 9/12; A43B 5/00; A43B 19/00; A43D 86/00; B32B 7/08; B32B 7/12; B32B 27/40; B32B 27/08; B32B 27/06; B32B 5/18

(52) U.S. Cl. CPC A43B 23/025; B32B 2437/02; A43B 7/06; A43B 7/125; A43B 9/02; A43B 9/12; A43B 5/00; A43B 19/00; A43B 23/0235; A43B 23/026; A43B 23/022; A43D 86/00; B32B 7/08; B32B 7/12; B32B 27/40; B32B 27/08; B32B 27/065; B32B 5/18; B32B 2307/724; B32B 2307/7265; A43B 1/14

(57) ABSTRACT

An item of footwear including an outsole secured to an upper is provided. A bootie is attached to the infill panel. The bootie and infill panel combine to form a cavity receiving the wearer's foot. The bootie is provided by a single air permeable, moisture vapor permeable, and waterproof sheet formed from a plurality of layers of material laminated together. The sheet forms at least one edge portion extending, at least one time, a distance between a toe end and a heel end of the bootie. A protection strip is attached to the outer surface of the sheet adjacent the at least one edge portion. A stitching seam is formed by a thread-type material securing the at least one edge portion of the bootie adjacent an outer peripheral edge portion of the infill panel. The thread-type material extends through the protection strip and the infill panel to form the seam.

### CROSS-REFERENCE TO RELATED PATENT APPLICATION

This patent application claims the benefit of U.S. Provisional Patent Application No. 62/501,214, filed May 4, 2017, the entire teachings and disclosure of which are incorporated herein by reference thereto.

### FIELD OF THE INVENTION

This invention generally relates to footwear and more particularly to forming an upper of a shoe that includes an infill panel.

### BACKGROUND OF THE INVENTION

At least some known shoe uppers are constructed of certain materials, including various fabrics and adhesives, that when assembled in layers have limited breathability. Similarly, footwear that is marketed as waterproof and breathable is constructed of multiple layers that might be waterproof and might be moisture vapor permeable but are not air permeable. The waterproof liner most commonly includes a layer of polyurethane or some other material that is not air permeable. This lack of air permeability seals in the wearer's foot without access to fresh air.

Construction of conventional uppers typically involves either the use of a pattern cutout from a material, or multiple pieces cut from a material and either the single piece or the multiple pieces assembled with stitching and adhesives to form a volume shaped to encompass a wearer's foot. Often, uppers are constructed in two parts, a liner and a shoe shell, wherein the waterproof liner must be assembled inside one or more layers of the shoe shell to complete the full upper of the shoe. However, methods used to improve the breathability of the shoe tend to reduce the waterproof capability of the shoe.

Further, as illustrated in FIG. 3 of U.S. Pat. Publ. No. 2010/0011619 (the '619 publication, which is reproduced herein), the upper of the shoe is often permanently attached to an insole (also referred to as an “infill panel”) by one or more insole seams, such as insole 304 being attached to bootie 302 seams 320 and 330 (also referred to as “stitching seams”) of the '619 publication. Unfortunately, the standard formation of seams 320 and 330 was performed by a Strobel stitch that when using delicate materials such as air permeable, moisture vapor permeable, and waterproof laminate materials will damage various layers of the material destroying the waterproof characteristic of the materials. It is noted that seams 320 and 330 are often formed as a single continuous seam. This typically occurs due to the compression of the insole 304 and bootie 302, which is formed from the air permeable, moisture vapor permeable, and waterproof laminate material being compressed between toothed rollers used in the Strobel stitch method.

More particularly, when using the Strobel stitch method, an inner surface of the insole 304 is placed against an inner surface of the material forming bootie 302 with free edges of the material aligned with one another. With the pieces of materials pressed together, the material is fed through a nip formed between a pair of drive wheels that have teeth to grip and drive the aligned pieces of material through the sewing machine as a stitch is applied to the pieces of material. A needle will penetrate through the pieces of material and a stitch will extend over the edges of the pieces of material. Again, as noted above, unfortunately, the pressure of the drive wheels and the required toothed configuration of the drive wheels will create depressions in the pieces of material. Unfortunately, this can create deformation to the various layers of the air permeable, moisture vapor permeable, and waterproof laminate material, which can result in potential leak paths through the permeable, moisture vapor permeable, and waterproof laminate material.

Another problem related to forming footwear items using the air permeable, moisture vapor permeable, and waterproof laminate material is that it is often difficult to seal the seams 320 and 330. This is often done by applying a sealing gasket 360 over the insole 304 and sealing the sealing gasket to bootie 302. However, due to the materials used to form bootie, i.e. air permeable, moisture vapor permeable, and waterproof laminate material, it is often difficult to obtain a good adhesive seal between the sealing gasket 360 and the bootie 302 to properly seal the upper prior to attaching to an outsole.

The present invention relates to improvements over the current state of the art.

### BRIEF SUMMARY OF THE INVENTION

Embodiments of the invention provide new and improved items of footwear and particularly uppers for items of footwear as well as methods of forming items of footwear and various components thereof.

In an embodiment, an item of footwear including an outsole and an upper is provided. The upper is operably secured to the outsole. The upper surrounds a wearer's foot in use. The upper includes an infill panel, a bootie, a protection strip and a stitching seam. The infill panel is located, at least in part, below the wearer's foot in use. The infill panel has an outer peripheral edge portion. The bootie extends over a top of the wearer's foot and is attached to the infill panel. The bootie and infill panel combine to form a cavity receiving the wearer's foot in use. The bootie is provided by a single air permeable, moisture vapor permeable, and waterproof sheet formed from a plurality of layers of material laminated together. The single air permeable, moisture vapor permeable, and waterproof sheet has an inner surface facing the wearer's foot and an outer surface facing opposite the inner surface in use. The single air permeable, moisture vapor permeable, and waterproof sheet forms at least one edge portion extending, at least one time, a distance between a toe end and a heel end of the bootie. Typically, it extends a majority of the distance between the toe end and the heel end of the bootie. The protection strip is attached to the outer surface of the single air permeable, moisture vapor permeable, and waterproof sheet adjacent the at least one edge portion. The stitching seam is formed by a thread-type material securing the at least one edge portion of the bootie adjacent the outer peripheral edge portion of the infill panel. The thread-type material extends through the protection strip and the infill panel to form the stitching seam.

In one embodiment, the protection strip has an inner surface secured to the outer surface of the single air permeable, moisture vapor permeable, and waterproof sheet and an opposite outer surface facing away from the inner surface. The outer surface of the protection strip provides an engagement surface for a sewing machine when forming the stitching seam.

In one embodiment, the stitching seam is formed from a strobel stitch.

In one embodiment, the protection strip is spaced at least 3 mm from the edge portion of the single air permeable, moisture vapor permeable, and waterproof sheet and no more than 10 mm from the edge portion of the single air permeable, moisture vapor permeable, and waterproof sheet.

In one embodiment, at least 15% of the outer surface of the single air permeable, moisture vapor permeable, and waterproof sheet is directly exposed to an external environment.

In one embodiment, a water proof gasket is secured to an outer surface of the infill panel and interposed between the infill panel and the outsole. An adhesive secures the water proof gasket to the infill panel.

In one embodiment, the water proof gasket entirely covers the stitching seam. The adhesive is located between the water proof gasket and the protection strip.

In one embodiment, the protection strip is a thermoplastic polyurethane adhesively secured to the outer surface of the single air permeable, moisture vapor permeable, and waterproof sheet.

In another embodiment, a method of forming an item of footwear is provided. The method includes forming an upper that will surround a wearer's foot in use. Forming the upper includes providing an infill panel. Forming the upper also includes providing a bootie formed from a single air permeable, moisture vapor permeable, and waterproof sheet formed from a plurality of layers of material laminated together. The single air permeable, moisture vapor permeable, and waterproof sheet has an inner surface facing the wearer's foot in use and an outer surface facing opposite the inner surface in use. The single air permeable, moisture vapor permeable, and waterproof sheet forms at least one edge portion extends a distance between a toe end and a heel end of the bootie. Typically the edge portion extends at least one time, a majority of the distance between a toe end and a heel end of the bootie. The method includes attaching a protection strip to the outer surface of the single air permeable, moisture vapor permeable, and waterproof sheet adjacent the at least one edge portion. The method includes securing the at least one edge portion of the bootie adjacent the outer peripheral edge portion of the infill panel with a stitching seam formed by a thread-type material. The thread-type material extending through the protection strip and the infill panel to form the stitching seam. The infill panel and the bootie form a cavity receiving the wearer's foot in use. The infill panel is located, at least in part, below the wearer's foot in use. The bootie extends over a top of the wearer's foot in us. The method includes operably securing the upper to an outsole.

In one embodiment, the protection strip has an inner surface secured to the outer surface of the single air permeable, moisture vapor permeable, and waterproof sheet and an opposite outer surface facing away from the inner surface. The stitching seam is formed using a sewing machine. The step of securing includes engaging the outer surface of the protection strip with the sewing machine when forming the stitching seam.

In one embodiment, the stitching seam is strobel stitched. The sewing machine includes a toothed wheel that drives the infill panel, air permeable, moisture vapor permeable, and waterproof sheet, and protection strip through the sewing machine. The toothed wheel engages the outer surface of the protection strip.

In one embodiment, driving the infill panel, protection strip and air permeable, moisture vapor permeable, and waterproof sheet through the sewing machine is not provided by directly engaging the air permeable, moisture vapor permeable, and waterproof sheet with the sewing machine.

In one embodiment, the protection strip is spaced at least 3 mm from the edge portion of the single air permeable, moisture vapor permeable, and waterproof sheet and no more than 10 mm from the edge portion of the single air permeable, moisture vapor permeable, and waterproof sheet.

In one embodiment, at least 15% of the outer surface of the single air permeable, moisture vapor permeable, and waterproof sheet is directly exposed to an external environment after the upper is secured to the outsole.

In one embodiment, the method includes attaching, with an adhesive, a water proof gasket to an outer surface of the infill panel, such that the water proof gasket is interposed between the infill panel and the outsole; and

[symbol]

In one embodiment, the water proof gasket entirely covers the stitching seam. The adhesive is located between the water proof gasket and the protection strip.

In one embodiment, the protection strip is a thermoplastic polyurethane adhesively secured to the outer surface of the single air permeable, moisture vapor permeable, and waterproof sheet.

In another embodiment, an item of footwear includes an outsole and an upper. The upper is operably secured to the outsole. The upper surrounds a wearer's foot in use. The upper includes an infill panel, a bootie, a protection strip, and a stitching seam. The infill panel is located, at least in part, below the wearer's foot in use. The infill panel has an outer peripheral edge portion. The bootie extends over a top of the wearer's foot attached to the infill panel. The bootie and infill panel combine to form a cavity receiving the wearer's foot in use. The bootie is provided by a single air permeable, moisture vapor permeable, and waterproof sheet formed from a plurality of layers of material laminated together. The single air permeable, moisture vapor permeable, and waterproof sheet has an inner surface facing the wearer's foot and an outer surface facing opposite the inner surface in use. The single air permeable, moisture vapor permeable, and waterproof sheet forms at least one edge portion extends, at least one time, a distance between a toe end and a heel end of the bootie. Typically, it extends a majority of the distance. The protection strip is attached to the outer surface of the single air permeable, moisture vapor permeable, and waterproof sheet adjacent the at least one edge portion. The stitching seam is formed by a thread-type material securing the at least one edge portion of the bootie adjacent the outer peripheral edge portion of the infill panel. The waterproof gasket is sealingly secured by an adhesive over the infill panel and the stitching seam. At least a portion of the adhesive is located between the waterproof gasket and the protection strip. The water proof gasket is positioned between the infill panel and the outsole.

In one embodiment, the protection strip is a thermoplastic polyurethane adhesively secured to the outer surface of the single air permeable, moisture vapor permeable, and waterproof sheet.

In another embodiment, a method of forming an item of footwear is provided. The method includes forming an upper that will surround a wearer's foot in use. The method includes providing an infill panel. The method includes providing a bootie formed from a single air permeable, moisture vapor permeable, and waterproof sheet formed from a plurality of layers of material laminated together. The single air permeable, moisture vapor permeable, and waterproof sheet has an inner surface facing the wearer's foot in use and an outer surface facing opposite the inner surface in use. The single air permeable, moisture vapor permeable, and waterproof sheet forms at least one edge portion extending, at least one time, a distance between a toe end and a heel end of the bootie. Typically, this distance is a majority of the distance. The method includes attaching a protection strip to the outer surface of the single air permeable, moisture vapor permeable, and waterproof sheet adjacent the at least one edge portion. The method includes securing the at least one edge portion of the bootie adjacent the outer peripheral edge portion of the infill panel with a stitching seam formed by a thread-type material. The infill panel and the bootie form a cavity receiving the wearer's foot in use with the infill panel located, at least in part, below the wearer's foot in use. The method includes attaching, with an adhesive, a water proof gasket to an outer surface of the infill panel and over the stitching seam. The water proof gasket is interposed between the infill panel and the outsole.

In an embodiment, attaching the water proof gasket entirely covers the stitching seam. The adhesive is located between the water proof gasket and the protection strip. The adhesive and water proof gasket prevent water permeability through the stitching seam.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of a footwear item in accordance with an embodiment of the present invention;

FIG. 2 is an enlarged cross-section of a multi-layer laminate sheet used to form the upper shown in FIG. 1;

FIG. 3 is a perspective view of a prior art upper during construction with the inside facing outward;

FIG. 4 is a perspective view of an upper according to an embodiment of the invention;

FIG. 5 is an illustration of the sheet of material used to form the bootie of the upper in FIG. 4 prior to being stitched; and

FIGS. 6 and 7 are simplified illustrations of a Strobel stitching method for connecting the bootie and insole of the upper illustrated in FIG. 4.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

A common limitation of footwear that is waterproof and moisture permeable is that such footwear is air impermeable. One example of an embodiment that does not exhibit the common air impermeability limitation is footwear having a upper made from a multi-layer laminate that is waterproof, moisture vapor permeable, and air permeable. The embodiments described herein include such an upper and a method for constructing such an upper.

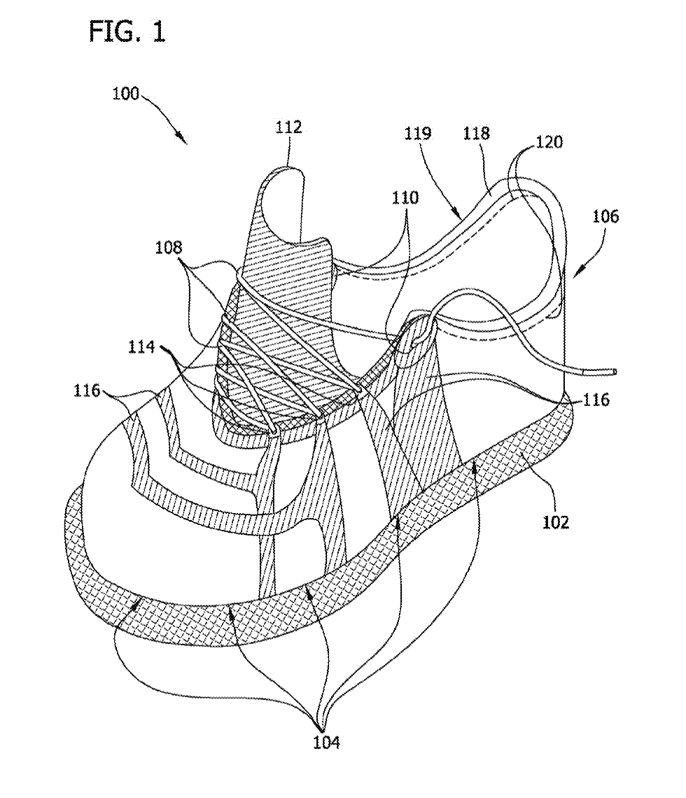

FIG. 1 is a perspective view of a footwear item 100 in accordance with an embodiment of the present invention. In the exemplary embodiment, footwear item 100 is illustrated as an athletic shoe. In various alternative embodiments, footwear item 100 may be another type of shoe, boot or footwear. Footwear item 100 includes an outsole 102, and an upper 104 configured to receive a foot (not shown) of a user (also referred to as a wearer) through an opening thereof. Upper 104 is formed, in part, from a bootie 106 that surrounds, at least in part, a user's foot. As will be described more fully, an insole (also referred to herein as an “infill panel”) is attached to the bootie 106. In various other embodiments, the outsole 102 may be formed and coupled to upper 104 by one or more of injection molding and vulcanizing. Footwear item 100 includes a front lacing 108 that is engaged to upper 104 using a plurality of fasteners 110.

Moreover, footwear item 100 includes a tongue 112 configured to permit contraction and expansion of upper 104 of footwear item 100, and particularly the opening thereof, so that footwear item 100 can accommodate insertions and removal of a foot. Tongue 112 also provides for adjustment of upper 104 so that footwear item 100 is firmly contacting and attached to the foot of the user when front lacing 108 is secured. In an alternative embodiment, front lacing 108 may be a hook and loop fastener material such as Velcro®. Tongue 112 is formed from existing material by tongue stitching 114. Fasteners 110 are attached to upper 104 at the edge of tongue 112. In various alternative embodiments, fasteners 110 may be one or more of the following: eyelets, eye stays, loop fasteners, and hooks.

Footwear item 100 also typically includes an exoskeleton 116 that includes material attached or molded to the outside surface of upper 104. Exoskeleton 116 provides structural support to upper 104 and facilitates maintaining a shape of upper 104. Exoskeleton 116 also facilitates dispersing lacing tension forces that act upon fasteners 110 outwardly across an area surrounding where exoskeleton 116 is attached as opposed to isolating the forces only where fasteners 110 are attached to upper 104. In the exemplary embodiment, exoskeleton 116 is attached to upper 104 by high frequency welding. In various alternative embodiments, exoskeleton 116 is attached using at least one of, but not limited to, stitching, adhesive bonding, heat welding (e.g. using a hot press) and high frequency welding. In the exemplary embodiment, footwear item 100 includes a cap 118 formed by doubling over a top edge 119 of upper 104 and maintained in position using for example, but not limited to, cap stitching 120. In the exemplary embodiment, upper 104 is secured to outsole 102 using an attachment process such as an adhesive process. However, as noted above, other processes for securing the upper 104 to the outsole 102 may be used, such as one or more of injection molding and vulcanizing.

The terms ‘waterproof’ and ‘liquid impermeable’ are used interchangeably throughout the present disclosure. As used herein, ‘liquid impermeable’ is defined as that which upper 104, including the insole, does not leak as indicated by the presence of detectable liquid on the exterior of upper 104 when applied with water having maximum pressure of 200 millibar (2.901 p.s.i.g.) for one minute.

In an exemplary sense, ‘air permeability’ of bootie 106 can be defined by the test method designated ASTM D737-96, by the American Society for Testing and Materials. This is preferably measured by a Frazier Air Permeability Tester, a Textest FX 3300 Air Permeability Tester or an equivalent type of testing device. The air permeability needs to provide for air flow of at least 0.03 cubic centimeters per minute per square centimeter at a pressure of a 1.27 centimeter water column (0.05 cubic feet per minute per square foot at a pressure of a 0.5 inch water column) through bootie 106 portion of upper 104. Preferably, there is air flow of at least 0.05 cubic centimeters per minute per square centimeter at a pressure of a 1.27 centimeter water column (0.1 cubic feet per minute per square foot at a pressure of a 0.5 inch water column) through bootie 106. More preferably there is air flow of at least 0.15 cubic centimeter per minute per square centimeter at a pressure of a 1.27 centimeter water column (0.3 cubic feet per minute per square foot at a pressure of a 0.5 inch water column) through bootie 106 and most preferably there is air flow of at least 0.51 cubic centimeter per minute per square centimeter at a pressure of a 1.27 centimeter water column (1.0 cubic feet per minute per square foot at a pressure of a 0.5 inch water column) through bootie 106.

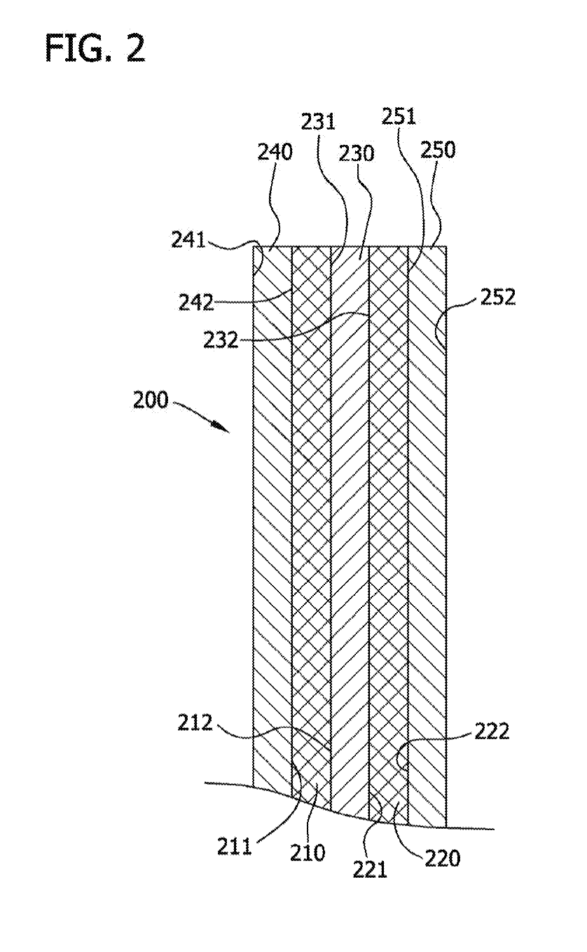

FIG. 2 is an enlarged cross-sectional view of an exemplary embodiment of a multi-layer laminated sheet 200 that may be used in the construction of upper 104 (shown in FIG. 1). In the exemplary embodiment, multi-layer laminated sheet 200 includes five layers. In various other embodiments, other numbers of layers may be used including one or more of the layers outlined below. For instance, it is contemplated that three and four layer materials providing adequate breathability and waterproof characteristics can be used.

A first layer 210 is an air permeable, moisture vapor permeable, and waterproof membrane material having a first side 211 and a second side 212. A second layer 220 is a padding material that is waterproof, and has been made air permeable and moisture vapor permeable by perforating the padding material. Second layer 220 includes a first side 221 and a second side 222. Second layer 220 is configured to facilitate protecting first layer 210 from a surrounding environment such as rocks and other externalities that could puncture or otherwise physically damage first layer 210. A third layer 230 is an air permeable and moisture vapor permeable bonding material having a first side 231 and a second side 232. Additionally, third layer 230 can be waterproof. A fourth layer 240 is an air permeable and moisture vapor permeable material having a first side 241 and a second side 242. Fourth layer 240 is configured to facilitate protecting first layer 210 from an inside surrounding environment, such as abrasion by a wearer's foot or sock. Additionally, fourth layer 240 can be waterproof. A fifth layer 250 is an air permeable and moisture vapor permeable material having a first side 251 and a second side 252. Fifth layer 250 is configured to form an outside surface of upper 104 (shown in FIG. 1). Additionally, fifth layer 250 can be waterproof.

In the exemplary embodiment, first layer 210 is formed of an air permeable, moisture vapor permeable, and waterproof material that includes microporous membranes. An example of such material is eVENT® Fabric, which is a chemically treated expanded polytetrafluoroethylene (hereinafter also referred to as ePTFE) membrane commercially available from BHA Technologies, Inc. of Kansas City, Mo.

Other exemplary commercial available materials that may be used for forming multilayer laminated sheet 200 are Gore-Tex™XCR™also known as VISI000001, TETRATEX®, SUPOR®, VERSAPOR®, PORELLE®, MILLIPORE®, ENTRANT®, FOLIO I™, ACE-SIL®, FLEX-SIL®, MICROPOR-SIL®, and CELLFORCE®.

Second layer 220 in the exemplary embodiment includes a closed-cell foam such as a polyester fiber foam commercially available as Nu-foam®. In various alternative embodiments, second layer 220 includes at least one of an open-cell foam or other padding-type materials. Although in an exemplary embodiment, the closed-cell foam is waterproof, it is also air impermeable and water vapor impermeable without certain modifications. Therefore to ensure that second layer 220 is air permeable and moisture vapor permeable, the material is perforated prior to being laminated into multi-layer laminated sheet 200. Although second layer 220 is perforated with a plurality of holes to enable it to be air permeable and water vapor permeable, but not waterproof, one or more layers of multi-layer laminated sheet 200, and at least first layer 210, is still waterproof and thus ensures that multi-layer laminated sheet 200 is waterproof.

Third layer 230 includes a bonding material to facilitate bonding of first layer 210 and second layer 220. Third layer 230 facilitates a strong bond that is often otherwise unreliable without the use of third layer 230. In the exemplary embodiment third layer 230 includes a textile material, for example, but not limited to, scrims, tricot knits, and non-wovens.

Fourth layer 240 is configured to form an inside surface, or lining of upper 104 (shown in FIG. 1) and to facilitate protecting first layer 210 from abrasion caused by a wearer's foot (not shown). As such, fourth layer 240 is configured to be able to withstand periodic abrasion from the wearer's foot as well as provide a level of comfort for the wearer's foot. In the exemplary embodiment, fourth layer 240 includes a textile fabric using at least one of, but not limited to, woven, non-woven, or knit fabrics. Other exemplary fabrics that may be utilized for fourth layer 240 are warp knit fabrics, including the ECLIPSE 100H™ (an abrasive resistant polyester and nylon combination fabric), ECLIPSE 200S™ (an abrasive resistant polyester and nylon combination fabric) and ECLIPSE 400H™ (a lightweight, nylon fabric), all commercial available from Tempo Shain Corporation of Salem, Mass.

Fifth layer 250 is configured to form an outside surface, or shell (not shown) of upper 104 (shown in FIG. 1) and is visible as an outside of shoe 100 (shown in FIG. 1) when worn by a wearer. In an exemplary embodiment, the material used for fifth layer 250 includes, but is not limited to, woven, non-woven, and knit fabrics.

It is noted that the single layer sheet above includes five layers. However, this is an exemplary embodiment and other embodiments could have more or less layers as long as the characteristics of the laminate are provided.

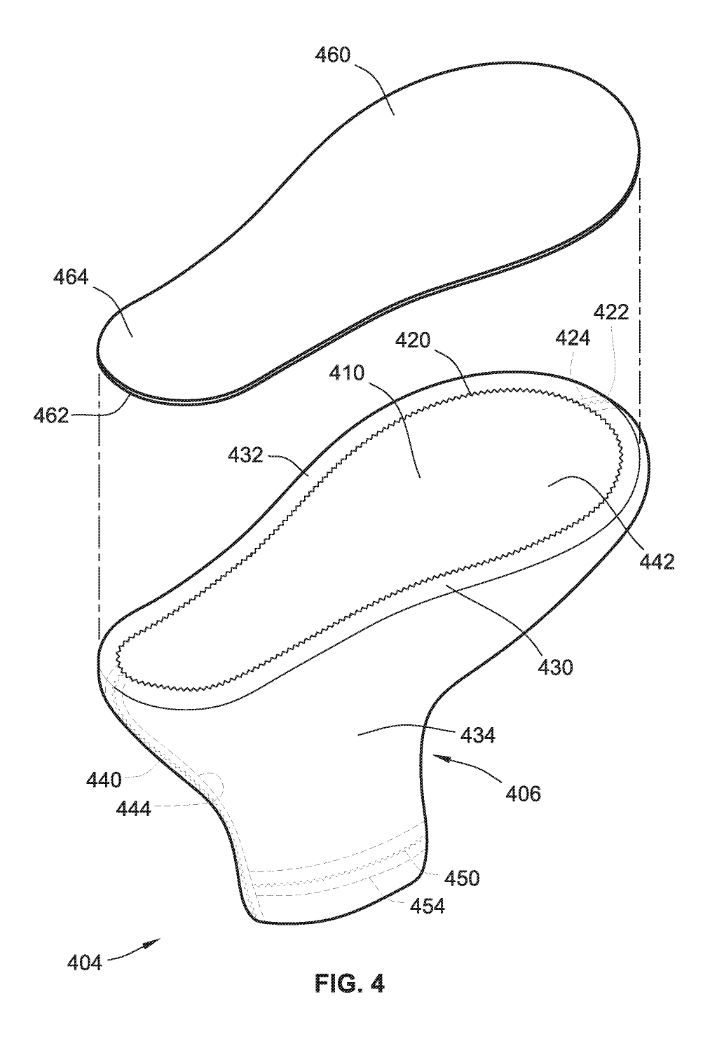

FIG. 4 is an exploded view of a pre-completion upper 404 in accordance with an exemplary embodiment of the present invention during construction. Upper 404 is illustrated prior to attaching any combination of a midsole, an outsole 102 (shown in FIG. 1), and an insole sealing gasket 460. In the exemplary embodiment a toe stitching seam 422 and a rear assembly stitching seam 440 form a one-piece of multi-layer laminate sheet 200 (shown in FIG. 2) into a bootie 406.

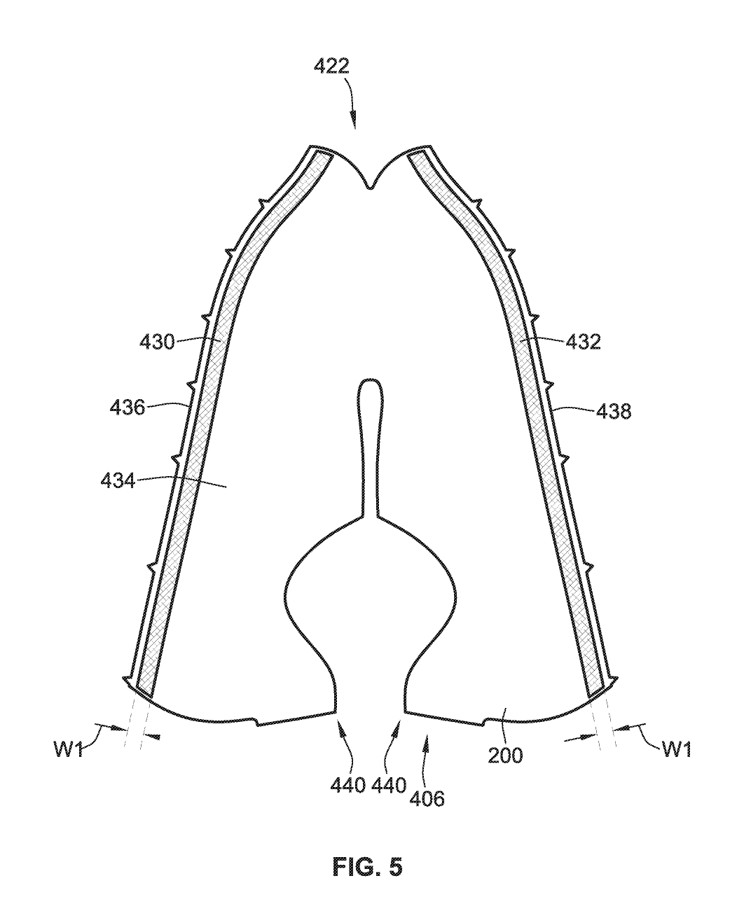

FIG. 5 illustrates the multi-layer laminate sheet 200 cut to shape and laid flat prior to being formed into the bootie 406 by toe stitching seam 422 and rear assembly stitching seam 440. Arrows 422A, 440A are used to illustrate where the toe stitching seam 422 and rear assembly stitching seam 440 will be added to the multi-layer laminate sheet 200 to form the bootie 406. Arrows 422A, 440A also generally illustrate the toe and heel ends of the multi-layer laminate sheet 200 prior to forming the bootie 406 with stitching seams 422, 440. These stitching seams 422, 440 will be added prior to attaching the insole 410.

Protection strips 430, 432 are attached to what will be the outer surface 434 of the multi-layer laminate sheet adjacent longitudinal edge portions 436, 438 that extend between the toe and heel ends 422A, 440A of the multi-layer laminate sheet 200. In some embodiments, the protection strips 430, 432 are formed from thermoplastic polyurethane adhesively secured to the outer surface 434 of the multi-layer laminate sheet. It is contemplated that adhesive to both the protection strips 430, 432 and the multi-layer laminate sheet 200. Alternatively, adhesive could be applied to a either the protection strip 430, 432 or the multi-layer laminate sheet 200. Further, heat and pressure can be applied after adhesive is applied to secure the protection strip 430, 432 in place. A further method could implement high frequency or radio frequency welding to secure the protection strip 430, 432 to the multi-layer laminate sheet 200. Preferably, the attachment between the protection strips 430, 432 is waterproof.

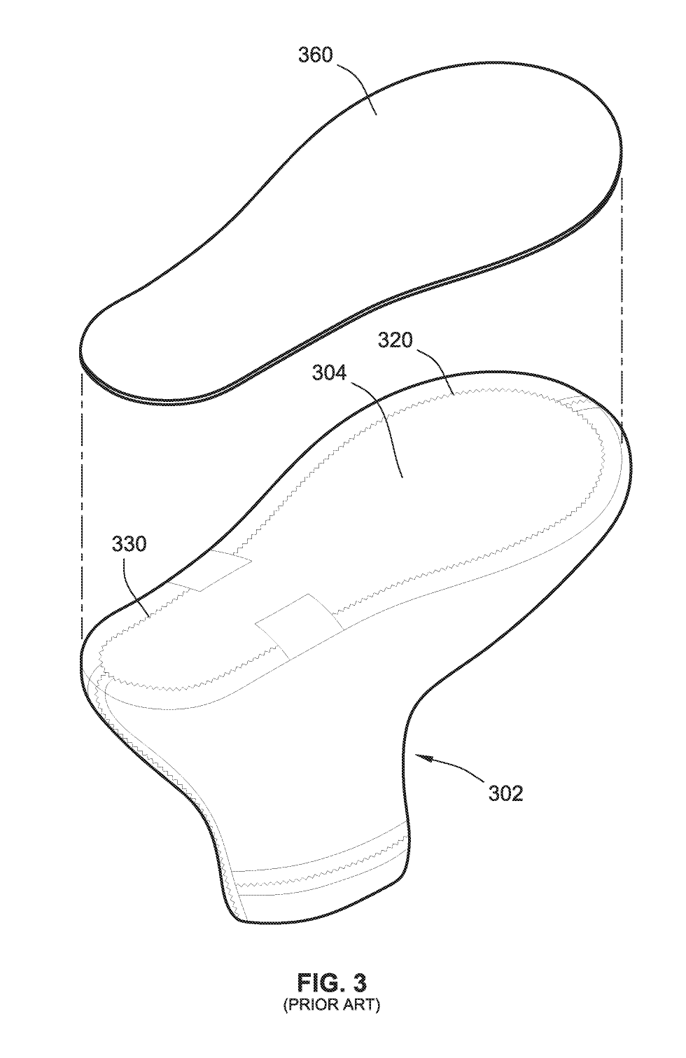

Bootie 406 and insole 410 are joined with insole stitching seam 420. While a single insole stitching seam 420 is illustrated, the insole stitching seam could be formed from multiple seams such as illustrated in the prior art FIG. 3, which includes a front insole stitching seam and a rear insole stitching seam. Flaps, such as illustrated in FIG. 3, may be provided at the beginning and ends of any of the insole stitching seams. The number of insole stitching seams and inclusion of flaps may depend on the type of stitching that is used.

Stitching seams 420, 422, 440, and 450 may use any of a wide variety of thread-type material, including, but not limited to, strands or cords and include spun fibers, spun fibers encircling a core filament, bonded fibers and monofilament-type material that may be coated with a liquid impermeable coating. Stitching seams 420, 422, 440, and 450 may also use any of a wide variety of stitching patterns, including, but not limited to: Strobel stitching and zig zag. In addition, adhesives may be utilized as well as electro-die sealing methods. It is also understood that the location and number of seams 420, 422, 440, and 450 can vary depending on the type of footwear item being produced.

In a preferred embodiment, stitching seam 420 uses the Strobel stitching method. The protection strips 430, 432 protect the multi-layer laminate sheet 200 from being damaged during the Strobel stitching process. More particularly, the protection strips 430, 432 prevent the multi-layer laminate sheet 200 from being directly contacted by the toothed wheels of a Stroble stitching sewing machine as well as prevent over compression of the multi-layer laminate sheet 200, which prevents undesirable plastic deformation of the sensitive layers of the multi-layer laminate sheet 200. Such deformation of the layers of the multi-layer laminate sheet 200, particularly when the multi-layer laminate sheet 200 is an air permeable, moisture vapor permeable, and waterproof sheet, has been found to create failures in the multi-layer laminate sheet 200 when exposed to repetitive bending that create leak paths through the bootie 406 destroying the waterproof characteristics of the bootie 406.

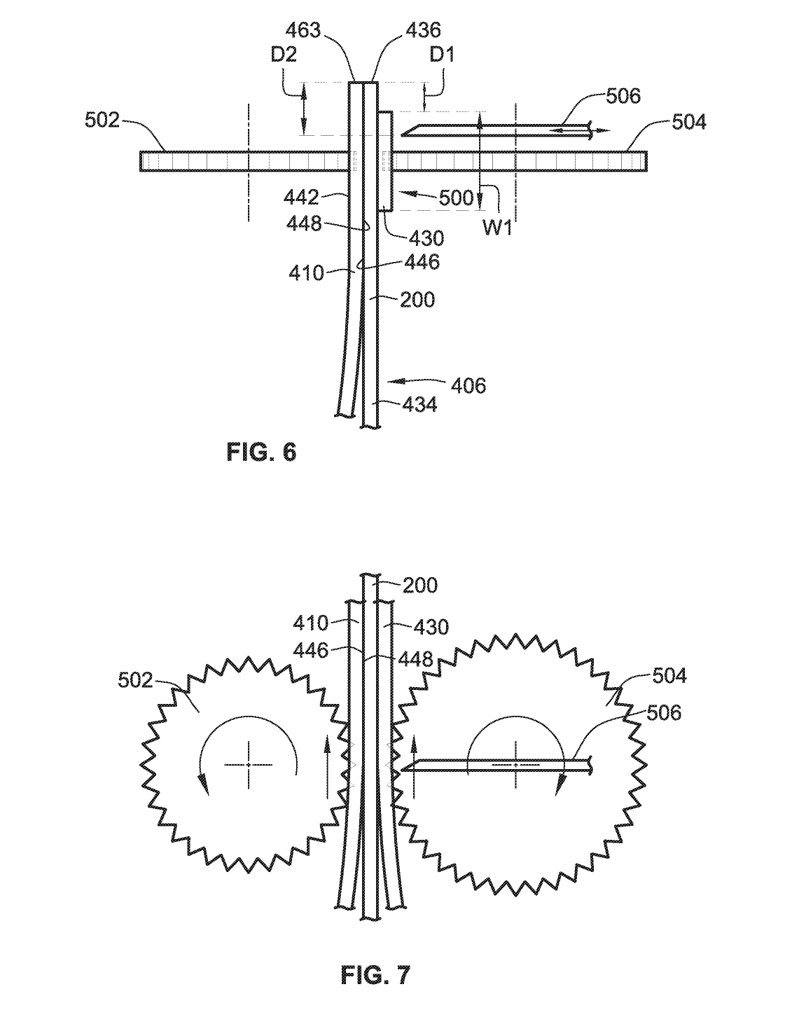

FIG. 6 schematically illustrates the formation of insole stitching seam 420 being formed using the Strobel method. In FIG. 6, the insole 410 is placed adjacent to the bootie 406 with the multi-layer laminate sheet 200 sandwiched between the insole 410 and the protection strip 430. It is noted that only a single protection strip 430 is illustrated but a similar orientation will exist with regard to the other protection strip 432. The description will thus only focus on protection strip 430. More particularly, the outer surface 434 of the multi-layer laminate sheet 200 is facing outward and away from an outer surface 442 of the insole 410. As such, an interior surface 446 of the multi-layer laminate sheet 200 is facing and positioned against an interior surface 448 of the insole 410.

FIG. 6 illustrates the insole 410, multi-layer laminate sheet 200 and protection strip 430 passing through a nip 500 formed between opposed toothed wheels 502, 504 that operably hold the various materials adjacent one another as well as drive the sandwiched materials through the nip 500 as the insole stitching seam 420 (not shown in FIG. 6) is being formed. Needle 506 is illustrated as being on the protection strip 430 side of the sandwich of materials but may alternatively be on the insole 410 side of the sandwich of materials.

Edge portions 463 and 436 of the insole 410 and multi-layer laminate sheet 200, respectively, are aligned during the stitching process. However, to provide am improved finish to the insole stitching seam 420, the protection strips 430, 432 (only 430 is shown in FIG. 6) are spaced a distance D1 away from edge portions 463 and 436. This spacing prevents an overly bulky seam as well as prevents the formation of creases at the toe and heel of the upper 404 due to the curved shape of the insole 410, such as illustrated in FIG. 4.

Preferably the needle and resulting stitches pass through all three of components of the sandwich including the insole 410, multi-layer laminate sheet 200 and the protection strip 430 or 432. However, it is contemplated that at least 85% and more preferably at least 95% of all stitches pass through all three of the insole 410, multi-layer laminate sheet 200 and the protection strip 430 or 432 while some stitches will only pass through the insole 410 and multi-layer laminate sheet 200. In an embodiment, the protection strips 430 and 432 are applied to the outer surface of the multi-layer laminate sheet 200 at a distance D1 of between about 3 and 7 mm and preferably about 5 mm from corresponding edge portions 436, 438. This positioning thus leaves a portion of the outer surface 434 of the multi-layer laminate sheet 200 between edge portions 436, 438 and the corresponding protection strips 430, 432 exposed.

To provide adequate protection during stitching and adhesion to the outer surface 434 of the multi-layer laminate sheet 200, the protection strips 430, 432 preferably have a width W1 of at least 10 mm and more preferably of at least 15 mm.

The needle 506 preferably penetrates the sandwich of the insole 410, multi-layer laminate sheet 200 and protection strip 430 at about 7 mm from edge portions 463, 436 so as to penetrate all three components.

Returning to FIG. 4, stitching seams 422, 440, and 450 can be sealed with seam tape 424, 444, and 454 positioned over stitching seams 422, 440, and 450, respectively. In some applications of the seam tape 424, 444 and 454, heat is then applied through the application of hot air, and pressure through a nip roll is then applied to the top of seam tape 424, 444 and 454. The heat from the hot air is preselected to soften the adhesive in seam tape 424, 444 and 454 without detrimentally affecting any of the desired qualities found in pre-completion upper 300 of footwear item. An application of heat preferably ranges from about 150 degrees Celsius (302 degrees Fahrenheit) to about 250 degrees Celsius (482 degrees Fahrenheit) for most applications. However, the temperatures can reach or exceed 750 degrees Celsius. A preferred application of pressure is from about 3 kilograms per square centimeter (42.67 pounds per square inch) gauge to about 5 kilograms per square centimeter (71.12 pounds per square inch) gauge. However, the applied temperature and pressure are dependent on the type of material used for upper 404, the threads used to create seams 420, 422, 440, and 450, the adhesives and the type of material utilized for seam tape 424, 444, and 454. By such a process, a solid structural weld is formed that provides at least a substantially liquid impermeable quality in seams 422, 440, and 450 that is approximately equivalent to the liquid impermeability quality of the remainder of upper 404 and insole 410 having seams 422, 440, and 450, covered and sealed as described further.

It is a benefit of the Strobel stitching method that the seam 420 is formed from an exterior side of the upper 404 (e.g. with the bootie 406 and insole 410 in an outside out orientation). However, it is contemplated that, typically, seams 422, 440, and 450 may be formed and seam ape 424, 444, and 454 will be applied with the multi-layer laminate sheet 200 forming bootie 406 in an inside out manner even though the resulting seams 422, 440, and 450 and corresponding seam tape 424, 444, 454 will typically all be located on an interior side of the upper 404 when the footwear item is finished. This is why these seams 422, 440, and 450 and the corresponding seam tape 424, 444, and 454 are illustrated in dashed lines in FIG. 4.

Subsequent to insole 410 being stitched to bootie 406, insole sealing gasket 460, having a first side 462 and a second side 464, is applied to insole 410 and bootie 406. A bonding agent, e.g. an adhesive, is applied to first side 462 of insole sealing gasket 460 as well as the base of upper 404 including covering insole stitching seam 420, insole 410 and at least an exposed portion of protection strips 430, 432. First side 462 of insole sealing gasket 460 is then attached to the base, covering insole stitching seam 420, insole 410 and at least an exposed portion of protections trips 430, 432, through the application of heat and pressure as described above. Sealing gasket 460 acts as a sealing agent for insole 410 and insole stitching seam 420. By such a process, a solid structural weld is formed that provides at least a substantially liquid impermeable quality in insole stitching seam 420 that is equivalent to the liquid impermeable quality of seams 422, 440, and 440, are with seam tape 424, 444, and 454.

The inclusion of the protection strips 430, 432 provides an additional advantage. More particularly, the protection strips 430, 432 can be selected to provide a strong and adequate waterproof connection between the sealing gasket 460 and the multi-layer laminate sheet 200. The protection strips 430, 432 can provide a bridge between the membrane layer(s) of the multi-layer laminate sheet 200 and the gasket 460. The protection strips 430, 432 are bonded to the membrane(s) through the face material of the multi-layer laminate sheet 200. Then, the gasket 460 is applied to the outer surface of the protection strips and a total seal is made.

In various alternative embodiments, insole 410 is impervious to both moisture vapor and air. As used herein liquid impermeable is defined as insole 410 not leaking, as indicated by detectable liquid on the exterior of insole 410 when applied with water having maximum pressure of 200 mbar (0.5 p.s.i.g.) for one minute.

In an exemplary embodiment, the absence of air permeability of insole 410 is defined by, for example, a test method designated ASTM D737-96, by the American Society for Testing and Materials. The air permeability is configured to provide for an air flow of less than 0.03 cubic centimeters per minute per square centimeter at a pressure of a 1.27 centimeter water column (0.05 cubic feet per minute per square foot at a pressure of a 0.5 inch water column) through insole 410.

In addition, in an alternative embodiment, insole 410 is substantially impervious to moisture vapor transmission. The liquid vapor permeability or the moisture vapor transmission rate of insole 410 may be defined by the test method designated JIS L 1099:1993 B2 by the Japanese Standards Association, which provides for less than 500 grams per square meter (14.85 ounces per square yard) of water vapor in a twenty-four hour period through insole 410.

In addition, in the exemplary embodiment, insole 410 is substantially inelastic. As used herein, “inelastic” is defined as material that, when subjected to a stress-strain test, provides less than 100% recovery when deflected more than 10% from a yield point.

In the exemplary embodiment, insole 410 includes, but is not limited to, inelastic and thermoplastic material, e.g., sheet goods, such as polypropylene, polyethylene, polyester, inelastic polyurethane, nylon, and vinyl. In an alternative embodiment, insole 410 includes, but is not limited to, fiber reinforced polymeric materials. This can include, but is not limited to, fibers made of polyester, nylon, polypropylene, polyethylene, rayon, and cotton. Yet in another alternative embodiment, insole 410 includes, but is not limited to, an all non-thermoplastic material such as reactive polyurethane, epoxy, styrene, butadiene, acrylic(s), and vulcanized rubber.

Other exemplary commercially available materials that may be used for forming insole 410 are BONTEX®, UPACO™, SOVERE™, MOREL™, ALCANTARA®, VITA™, RHENOFLEX®, and FOOTLEVERS®.

In an alternative embodiment, insole 410 is moisture permeable. Exemplary commercially available materials that may be used for forming a moisture permeable insole 410 are PORELLE®, PORON®, and TEXON®.

After the sealing gasket 460 is attached, the outsole 102 is attached to upper 404. The outsole 102 will cover the sealing gasket 460. Toe and heal caps may also be provided, typically between the upper and the outsole 102 to cover stitching seams 422 and 440.

A liner may be attached to the bootie 406 to protect the inner surface of the bootie 406 and particularly to prevent the user's foot or socks from wearing directly on the inner layer of multi-layer laminate sheet 200.

Typically, if an exoskeleton such as exoskeleton 116 is added, this will be applied to the outer surface of the bootie 406 prior to forming the bootie 406, e.g. forming stitching seams 422 and 440. Further, a portion of the exoskeleton may run around toward the bottom of the bootie 406 such that it is located between the upper 404 and the outsole 102 when fully assembled to increase the structural strength provided by the exoskeleton.

To provide for the desired breathability, bootie 406, which is formed from the multi-layer laminate sheet 200 that provides the breathability characteristics, generally forms a large percentage of the surface area of the upper exposed to the exterior environment when the resulting footwear item is worn. Preferably, any exoskeleton 116 or other material, e.g. design material such as for logos etc., applied to the outer surface of the bootie 406/upper 404, and particularly to the multi-layer laminate sheet 200, covers as little as possible of the outer surface of the bootie 406 when the footwear item is fully assembled. This prevents the added material attached to the outer surface of the multi-layer laminate sheet 200 from inhibiting the breathability of the bootie 406 and ultimately the footwear item. While it is preferred to have as much surface area of the bootie 406 directly exposed to the outside surrounding environment, i.e. in direct contact with the outside surrounding environment, as little as 10% of the outer surface of the multi-layer laminate sheet 200 may be exposed to the surrounding environment when the footwear item is fully assembled. In other embodiments, at least 15% is exposed to the outside surrounding environment. More preferably at least 20% is exposed to the outside surrounding environment. This percentage is measured from the total surface area of the bootie 402 prior to attachment of the outsole 102.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An item of footwear comprising:
an outsole; and
an upper operably secured to the outsole, the upper surrounding a wearer's foot in use, the upper including:
an infill panel located, at least in part, below the wearer's foot in use, the infill panel having an outer peripheral edge portion;
a bootie extending over a top of the wearer's foot, in use, is attached to the infill panel, the bootie and infill panel combining to form a cavity receiving the wearer's foot in use, the bootie provided by a single air permeable, moisture vapor permeable, and waterproof sheet formed from a plurality of layers of material laminated together, the single air permeable, moisture vapor permeable, and waterproof sheet having an inner surface facing the wearer's foot and an outer surface facing opposite the inner surface in use, the single air permeable, moisture vapor permeable, and waterproof sheet forming at least one edge portion extending, at least one time, a majority of a distance between a toe end and a heel end of the bootie;
a protection strip attached to the outer surface of the single air permeable, moisture vapor permeable, and waterproof sheet adjacent the at least one edge portion; and
a stitching seam formed by a thread-type material securing the at least one edge portion of the bootie adjacent the outer peripheral edge portion of the infill panel, the thread-type material extending through the protection strip and the infill panel to form the stitching seam.

2. The item of footwear of claim 1, wherein the protection strip has an inner surface secured to the outer surface of the single air permeable, moisture vapor permeable, and waterproof sheet and an opposite outer surface facing away from the inner surface, the outer surface of the protection strip providing an engagement surface for a sewing machine when forming the stitching seam.

3. The item of footwear of claim 2, wherein the stitching seam is formed from a strobel stitch.

4. The item of footwear of claim 1, wherein the protection strip is spaced at least 3 mm from the edge portion of the single air permeable, moisture vapor permeable, and waterproof sheet and no more than 10 mm from the edge portion of the single air permeable, moisture vapor permeable, and waterproof sheet.

5. The item of footwear of claim 1, wherein at least 15% of the outer surface of the single air permeable, moisture vapor permeable, and waterproof sheet is directly exposed to an external environment.

6. The item of footwear of claim 1, further comprising:
a water proof gasket secured to an outer surface of the infill panel and interposed between the infill panel and the outsole; and
an adhesive securing the water proof gasket to the infill panel.

7. The item of footwear of claim 6, wherein:
the water proof gasket entirely covers the stitching seam; and
the adhesive is located between the water proof gasket and the protection strip.

8. The item of footwear of claim 1, wherein the protection strip is a thermoplastic polyurethane adhesively secured to the outer surface of the single air permeable, moisture vapor permeable, and waterproof sheet.

9. A method of forming an item of footwear comprising:
forming an upper that will surround a wearer's foot in use, forming the upper including:
providing an infill panel;
providing a bootie formed from a single air permeable, moisture vapor permeable, and waterproof sheet formed from a plurality of layers of material laminated together, the single air permeable, moisture vapor permeable, and waterproof sheet having an inner surface facing the wearer's foot in use and an outer surface facing opposite the inner surface in use, the single air permeable, moisture vapor permeable, and waterproof sheet forms at least one edge portion extending, at least one time, a majority of a distance between a toe end and a heel end of the bootie;
attaching a protection strip to the outer surface of the single air permeable, moisture vapor permeable, and waterproof sheet adjacent the at least one edge portion;
securing the at least one edge portion of the bootie adjacent the outer peripheral edge portion of the infill panel with a stitching seam formed by a thread-type material, the thread-type material extending through the protection strip and the infill panel to form the stitching seam, wherein the infill panel and the bootie form a cavity receiving the wearer's foot in use with the infill panel located, at least in part, below the wearer's foot in use and the bootie extending over a top of the wearer's foot in use; and
operably securing the upper to an outsole.

10. The method of claim 9, wherein the protection strip has an inner surface secured to the outer surface of the single air permeable, moisture vapor permeable, and waterproof sheet and an opposite outer surface facing away from the inner surface;
wherein the stitching seam is formed using a sewing machine and the step of securing includes engaging the outer surface of the protection strip with the sewing machine when forming the stitching seam.

11. The method of claim 10, wherein the stitching seam is strobel stitched, the sewing machine includes a toothed wheel that drives the infill panel, air permeable, moisture vapor permeable, and waterproof sheet, and protection strip through the sewing machine, the toothed wheel engages the outer surface of the protection strip.

12. The method of claim 11, wherein driving the infill panel, protection strip and air permeable, moisture vapor permeable, and waterproof sheet through the sewing machine does not include directly engaging the air permeable, moisture vapor permeable, and waterproof sheet with the sewing machine.

13. The method of claim 9, wherein attaching the protection strip is spaced at least 3 mm from the edge portion of the single air permeable, moisture vapor permeable, and waterproof sheet and no more than 10 mm from the edge portion of the single air permeable, moisture vapor permeable, and waterproof sheet.

14. The method of claim 9, wherein at least 15% of the outer surface of the single air permeable, moisture vapor permeable, and waterproof sheet is directly exposed to an external environment after the upper is secured to the outsole.

15. The method of claim 9, further comprising:
attaching, with an adhesive, a water proof gasket to an outer surface of the infill panel, such that the water proof gasket is interposed between the infill panel and the outsole.

16. The method of claim 15, wherein:
the water proof gasket entirely covers the stitching seam; and
the adhesive is located between the water proof gasket and the protection strip.

17. The method of claim 9, wherein the protection strip is a thermoplastic polyurethane adhesively secured to the outer surface of the single air permeable, moisture vapor permeable, and waterproof sheet.

18. An item of footwear comprising:
an outsole; and
an upper operably secured to the outsole, the upper surrounding a wearer's foot in use, the upper including:
an infill panel located, at least in part, below the wearer's foot in use, the infill panel having an outer peripheral edge portion
a bootie extending over a top of the wearer's foot is attached to the infill panel, the bootie and infill panel combining to form a cavity receiving the wearer's foot in use, the bootie provided by a single air permeable, moisture vapor permeable, and waterproof sheet formed from a plurality of layers of material laminated together, the single air permeable, moisture vapor permeable, and waterproof sheet having an inner surface facing the wearer's foot and an outer surface facing opposite the inner surface in use, the single air permeable, moisture vapor permeable, and waterproof sheet forming at least one edge portion extending, at least one time, a majority of a distance between a toe end and a heel end of the bootie;
a protection strip attached to the outer surface of the single air permeable, moisture vapor permeable, and waterproof sheet adjacent the at least one edge portion;
a stitching seam formed by a thread-type material securing the at least one edge portion of the bootie adjacent the outer peripheral edge portion of the infill panel; and
a waterproof gasket sealingly secured by an adhesive over the infill panel and the stitching seam, at least a portion of the adhesive is located between the waterproof gasket and the protection strip, the water proof gasket is positioned between the infill panel and the outsole.

19. The item of footwear of claim 18, wherein the protection strip is a thermoplastic polyurethane adhesively secured to the outer surface of the single air permeable, moisture vapor permeable, and waterproof sheet.

20. A method of forming an item of footwear comprising:
forming an upper that will surround a wearer's foot in use, forming the upper including:
providing an infill panel;
providing a bootie formed from a single air permeable, moisture vapor permeable, and waterproof sheet formed from a plurality of layers of material laminated together, the single air permeable, moisture vapor permeable, and waterproof sheet having an inner surface facing the wearer's foot in use and an outer surface facing opposite the inner surface in use, the single air permeable, moisture vapor permeable, and waterproof sheet forms at least one edge portion extending, at least one time, a majority of a distance between a toe end and a heel end of the bootie;
attaching a protection strip to the outer surface of the single air permeable, moisture vapor permeable, and waterproof sheet adjacent the at least one edge portion;
securing the at least one edge portion of the bootie adjacent the outer peripheral edge portion of the infill panel with a stitching seam formed by a thread-type material, wherein the infill panel and the bootie form a cavity receiving the wearer's foot in use with the infill panel located, at least in part, below the wearer's foot in use,
attaching, with an adhesive, a water proof gasket to an outer surface of the infill panel and over the stitching seam, the water proof gasket being interposed between the infill panel and the outsole.

21. The method of claim 20, wherein attaching the water proof gasket entirely covers the stitching seam; and
the adhesive is located between the water proof gasket and the protection strip;
the adhesive and water proof gasket preventing water permeability through the stitching seam.
